(19) United States
(12) Patent Application Publication
(10) Pub. No.: US 2005/0183330 A1
(43) Pub. Date: Aug. 25, 2005

(54) Method and apparatus to procure and grow medicinal plants

(76) Inventor: Thomas E. Rudolph, Grizzly Flats, CA (US)

Correspondence Address: JOHN P. O'BANION;O'BANION & RITCHEY LLP, 400 CAPITOL MALL SUITE 1550, SACRAMENTO, CA, 95814, US

(21) Appl. No.: 11/033,995

(22) Filed: Jan. 11, 2005

Related U.S. Application Data
(60) Provisional application No. 60/540,729, filed on Jan. 30, 2004.
(60) Provisional application No. 60/568,061, filed on May 3, 2004.
(60) Provisional application No. 60/623,402, filed on Oct. 28, 2004.

(51) Int. Cl. A01G 9/14; A01G 1/00

(52) U.S. Cl. 47/58.1 FV

(57) ABSTRACT

An apparatus and method to procure medicinal plants for a patient with a valid medical prescription for a medicinal plant and meet current or proposed regulatory requirements. A self-contained medicinal plant grow environment allows an individual with a valid prescription to grow the medicinal plants to maturity at a selected location. A procurement method uses a broker to transfer a quantity of medicinal plants from a first patient to a second patient. A tracking certificate provides a document of the origin of a medicinal plant grown according to the apparatus and method of the invention. The invention provides for security and accountability for medicinal plants subject to government regulation and controls and can be adapted to situations relating to regulated possession quantity of medicinal plants and to government levied fees and taxes.

### CROSS-REFERENCE TO RELATED APPLICATIONS

This application claims priority from U.S. provisional application Ser. No. 60/540,729 filed on Jan. 30, 2004, incorporated herein by reference in its entirety, U.S. provisional application Ser. No. 60/568,061 filed on May 3, 2004, incorporated herein by reference in its entirety, and U.S. provisional application Ser. No. 60/623,402 filed on Oct. 28, 2004, incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND OF THE INVENTION

1. Field of the Invention of the Invention

This invention pertains generally to medicinal plants, and more particularly to a business method and apparatus for growing and harvesting medicinal plants in the current and proposed regulatory environment.

2. Description of Related Art

Medicinal plants have been cultivated and processed by individuals, families and communities from the beginning of humankind. Preparation methods for a myriad of medicinal use plants have been handed down, modified or lost over time. For many years, the cultivation, preparation, and use of certain medicinal plants was limited, if not prohibited completely, by leaders, religion or government.

In recent years, government restrictions on the cultivation, preparation, and/or use of certain medicinal plants have revised or relaxed. As such, needs have arose for secure facilities in which medicinal plants can be cultivated, prepared, used, and exchanged by persons who are authorized to do so. In some situations, the quantity of a medicinal plant possessed by an individual is regulated or used for legal guidance.

In some situations, complex legal regulations make it difficult for authorized patients to procure medicinal plants. There are no government approved or regulated production and distribution systems for some medicinal plants. Even with a valid prescription, each patient must individually address legal pratfalls with procurement and possession of medicinal plants. This is very difficult for some individuals, especially those with a debilitating condition for which the medicinal plant is prescribed.

For example, in California, use of certain medicinal plants is allowed under proposition 215 and proposed SB 420. However, the California Legislature has not clearly defined neither a comprehensive production plan nor a comprehensive distribution plan. These critical plan aspects have yet to be resolved, and as such represent the undefined provisions of SB 420. Section 1, Paragraph C of SB 420 states:
“It is also the intent of the Legislature to address additional issues that were not included within the act, and that must be resolved in order to promote the fair and orderly implementation of the act.”

Other additional unresolved issues surrounding SB 420 are generally understood to include: Ensuring the security and nondiversion of medicinal plants grown for medical use throughout all production, processing and distribution functions, compensation to the grower-patient for providing a portion of his medicinal plant crop to the non-growing patient population and, Government reimbursement for the services it provides. SB 420 currently leaves no wiggle room: medicinal plants grown for medical use must be grown by patients, kept secure, and kept isolated from the black market. As such, the individual grower-patient is the sole responsible party under SB 420.

Thus, in California a medicinal plant patient has a myriad of individual responsibilities including: maintaining a valid prescription, maintaining a legal ID for possession and use, demonstrating point of origin and disposition of each filled prescription and demonstrating any stored inventory is secure. If a patient attempts to grow their own crop, they must also deal with having a suitable grow space with appropriate utilities, safety and security, growing, watering, feeding, harvesting and curing the crop, disposing the waste, providing secure storage and demonstrating the crop production is within legal limits. Because of these difficulties, some patient resort to an illegal drug dealer or a quasi-legal club or cooperative to fill a valid, legal prescription.

In some jurisdictions, a distribution system for medicinal plants must demonstrate a nondiversionary intent and provide an auditable tracking system to ensure accountability. In other jurisdictions, medicinal plants cannot be diverted, transferred or sold directly between qualified patients or sold by a qualified patient to another for a profit.

Accordingly, the present invention seeks to address one or more of the above-described situations and needs.

### BRIEF SUMMARY OF THE INVENTION

This invention is a business method and apparatus that provide a viable means to procure and possess medicinal plants to fill a valid medical prescription and meet current or proposed regulatory requirements. The invention also provides a self-contained medicinal plant grow environment that allows an individual to grow the plants to maturity at a selected location. The invention provides for security and accountability for medicinal plant life subject to government regulation and controls and the invention can be adapted to situations relating to regulated possession quantity of medicinal plants.

An aspect of the invention is an apparatus for growing medicinal plants comprising a grow environment enclosure, a support structure positioned in the grow environment enclosure and adapted to support growing medicinal plants, an irrigation system coupled to the support structure and adapted to irrigate medicinal plants, plant media positioned on the support structure and adapted to grow medicinal plants, a light system positioned in the grow environment enclosure and adapted for growing medicinal plants, means for transporting the grow environment enclosure, and means for securing the grow environment enclosure.

Another aspect of the invention is an apparatus where the transporting means comprises a trailer adapted to tow behind a vehicle.

A further aspect of the invention is an apparatus where the transporting means is configured to be disabled when medicinal plants are growing in the grow environment enclosure.

A still further aspect of the invention is an apparatus where the grow environment enclosure is configured as a roll off container.

Another aspect of the invention is where the securing means comprises an alarm, and where the alarm is configured to annunciate when attempted unauthorized access to the grow environment enclosure is detected.

A further aspect of the invention is where the securing means comprises a transmitting global positioning system, and where the transmitting global positioning system is configured to transmit the location of the grow environment enclosure.

A still further aspect of the invention is where the securing means comprises a tamper-proof door coupled to the grow environment enclosure, and where the tamper-proof door is adapted to prevent access to the grow environment enclosure.

Another aspect of the invention is where the securing means comprises a radio receiver coupled to the grow environment enclosure, where the radio receiver is configured to allow access through the tamper-proof door upon a receipt of a coded radio signal, and a radio transmitter configured to send a coded radio signal to the radio receiver when access to the grow environment enclosure is authorized.

A further aspect of the invention is where the securing means comprises a motion detector adapted to detect motion in the grow environment enclosure.

A still further aspect of the invention is where the securing means comprises a video camera adapted to transmit images from within the grow environment enclosure.

Another aspect of the invention is where the securing means comprises a video camera adapted to transmit images from outside the grow environment enclosure.

A further aspect of the invention is a climate control system adapted to control the environment within the grow environment enclosure.

A yet further aspect of the invention is a water circulation and storage system adapted to couple to the irrigation system.

Another aspect of the invention is a CO₂ enrichment system.

A further aspect of the invention is an apparatus for growing medicinal plants that comprises a grow environment enclosure, where the grow environment enclosure is configured to be portable, a support structure positioned in the grow environment enclosure and adapted to support growing medicinal plants, an irrigation system coupled to the support structure and adapted to irrigate medicinal plants, plant media, positioned on the support structure and adapted to grow medicinal plants, a light system positioned in the grow environment enclosure and adapted for growing medicinal plants, a tamper-proof door coupled to the grow environment enclosure, where the tamper-proof door is adapted to prevent access to the grow environment enclosure, and an alarm coupled to the grow environment enclosure and configured to annunciate when attempted unauthorized access to the grow environment enclosure is detected.

A still further aspect of the invention is a radio receiver coupled to the grow environment enclosure, where the radio receiver is configured to allow access through the tamper-proof door upon a receipt of a coded radio signal, and a radio transmitter configured to send a coded radio signal to the radio receiver when access to the grow environment enclosure is authorized.

Another aspect of the invention is a water circulation storage system adapted to couple to the irrigation system.

A further aspect of the invention is a self-contained grow enclosure for growing medicinal plants comprising plant media adapted to grow medicinal plants in the grow enclosure, a grow table adapted to support medicinal plants and the plant media, a light system positioned in the grow enclosure and adapted for growing medicinal plants, a ventilation system adapted to control climate conditions in the grow enclosure, a controller adapted to monitor environmental conditions in the grow enclosure and control the ventilation system, means for water handling positioned in the grow enclosure and adapted to irrigate medicinal plants, and means for securing adapted to prevent access or tampering with the grow enclosure.

A still further aspect of the invention is where the securing means comprises a video system adapted to monitor the interior and exterior of the grow environment.

Another aspect of the invention is where the securing means comprises an entry door adapted to prevent entry to the grow environment, the entry door further having a coded lock.

A further aspect of the invention is where the water handling means comprises a reservoir tank adapted hold water, an air pump adapted to aerate the reservoir tank, a circulation pump adapted to mix water in the reservoir tank, a transfer pump adapted to transfer water from the reservoir tank to the grow table, where the air pump, the circulation pump and the transfer pump are controlled by the controller, and a water supply valve adapted to maintain the water level in the reservoir.

A still further aspect of the invention is a fertilizer dispenser adapted to add fertilizer to the water reservoir, and a fertilizer meter adapted to maintain a fixed ratio of fertilizer and water in the reservoir.

A yet further aspect of the invention is where the grow environment is modular and adapted to be permanently positioned at a location.

Another aspect of the invention is where the grow environment is portable and adapted to be temporarily positioned on a site.

A further aspect of the invention is a method for using a grow environment enclosure adapted for growing medicinal plants that comprises providing a portable grow environment enclosure having a medicinal plant support structure, an irrigation system, a light system and a security system, preparing the medicinal plant support structure for a grow cycle of medicinal plants with media, nutrients and seeds or cuttings, transporting the grow environment enclosure to a host site, operating the irrigation system and the light system, completing a grow cycle of the medicinal plants, transporting the grow environment enclosure from the host site to a location adapted for harvesting medicinal plants, and harvesting the medicinal plants at the location.

A still further aspect of the invention is providing a climate control system for the grow environment enclosure.

Another aspect of the invention is providing a CO₂ enrichment system for the grow environment enclosure.

A further aspect of the invention is providing a radio receiver adapted to receive an access code to permit access to the grow environment enclosure.

A still further aspect of the invention is connecting electricity to the grow environment enclosure.

Another aspect of the invention is where the host site is controlled by a patient with a physician issued prescription for medicinal plants.

A further aspect of the invention is a method for procuring a medicinal plant for a patient having a physician issued prescription for medicinal plants that comprises providing a grow cycle facility, a harvest/cure facility and a process/package facility, verifying the prescription with the issuing physician, growing the medicinal plant in the grow cycle facility, transferring the medicinal plant the harvest/cure facility, harvesting and curing the medicinal plant in the harvest/cure facility, transferring the medicinal plant to the process/package facility, packaging the medicinal plant in the process/package facility, and delivering the packaged medicinal plant to the patient.

A still further aspect of the invention is providing a security manager, witnessing the transfer of the medicinal plant from the grow cycle facility to the harvest/cure facility by the security manager, and witnessing the transfer of the medicinal plant from the harvest/cure facility to the process/package facility by the security manager.

Another aspect of the invention is preparing a chain of custody tracking certificate witnessed and signed by the security manager, and providing the chain of custody tracking certificate to the patient.

A further aspect of the invention is a method of procuring medicinal plants for a patient having a physician issued prescription for medicinal plant comprising providing a grow facility and a curing facility, verifying the identity of the patient by matching at least two identification cards with the patient, verifying the medicinal plant prescription by contacting the issuing physician, preparing a written agreement to grow medicinal plants, growing medicinal plants in the grow facility, curing the medicinal plants in the curing facility, packaging the cured medicinal plants, and distributing the packaged medicinal plants to the patient.

A still further aspect of the invention is providing a secure storage facility, and storing the packaged medicinal plants in the secure storage facility.

Another aspect of the invention is dividing the cured medicinal plants into usable and unusable medicinal plant material, disposing of the unusable harvested medicinal plant material, and packaging the usable harvested plant material.

A further aspect of the invention is processing the cured medicinal plants into edible medicinal plant products.

A still further aspect of the invention is a method of distributing medicinal plants from a first patient with a first prescription for medicinal plants and possessing a quantity of medicinal plants to a second patient having a second prescription for medicinal plants comprising transferring a portion of the quantity of medicinal plants from the first patient to the custody of a broker, verifying the identity and second prescription of the second patient, and transferring the portion of the quantity of medicinal plants from custody of the broker to the second patient.

Another aspect of the invention is transferring a first fee from the broker to the first patient, and transferring a second fee from the second patient to the broker.

A further aspect of the invention is placing the quantity of medicinal plants from the first patient in custody of a process manager, and transferring a portion of the quantity of medicinal plants from the process manager to the broker.

A still further aspect of the invention is a method of distributing medicinal plants from a first patient with a first prescription for medicinal plants and possessing a quantity of medicinal plants to a second patient having a second prescription for medicinal plants comprising transferring a portion of the quantity of medicinal plants from the first patient to custody of a process manager, packaging the portion of medicinal plants, transferring the packaged portion of medicinal plants from the process manager to custody of the broker, verifying the identity and second prescription of the second patient, and transferring the packaged portion of medicinal plants from custody of the broker to the second patient.

Another aspect of the invention is transferring a first fee from the broker to the process manager, transferring a second fee from the process manager to the first patient, and transferring a third fee from the second patient to the broker.

A further aspect of the invention is calculating the first fee based on total reimbursement value of producing the portion of medicinal plants, and calculating the second fee based on reimbursement value to the first patient of producing the portion of medicinal plants.

A still further aspect of the invention is a method of providing a chain of custody tracking document for growing a medicinal plant for a patient having a physician issued prescription for a medicinal plant comprising providing a growing manager, a curing manager a security manager and a tracking certificate, growing a medicinal plant under control of the grow manager, harvesting the medicinal plant by the grow manager, documenting harvest and measurement of the medicinal plant by the grow manager, the curing manager and the security manager on the tracking certificate, curing the harvested medicinal plant under control of the curing manager, documenting measurement and packaging of the cured medicinal plant by the curing manager and the security manager on the tracking certificate, and issuing the tracking certificate to the patient.

Another aspect of the invention is preserving at least one sample of the medicinal plant for genetic evidence, and attaching the sample to the tracking certificate.

A further aspect of the invention is dividing the harvested medicinal plant into usable and unusable medicinal plant material, measuring the usable harvested plant material, measuring the unusable harvested plant material, disposing of the unusable harvested medicinal plant material, and providing a certificate of disposal with the measurement of the unusable medicinal plant material to the patient.

A still further aspect of the invention is providing a process manager, processing the cured medicinal plants under control of the process manager, and documenting measurement and packaging of the processed medicinal plant by the process manager and the security manager on the tracking certificate.

Another aspect of the invention is storing the processed medicinal plants in a secure storage, and documenting the quantity of the processed medicinal plants stored by the process manager and the security manager on the tracking certificate.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is an organizational chart of a compassionate caregiver services support center (CCSSC) in accordance with the present invention.

FIG. 2 is a flow chart for a method of issuing a qualified patient ID card, preferably in the CCSSC described in FIG. 1.

FIG. 3 illustrates a flow chart for a method for procuring prescribed medicinal plants in a CCSSC as described in FIG. 1.

FIG. 4 illustrates a flowchart for a method of preparing a chain of custody tracking certificate for MP, and in conjunction with the method for procuring described in FIG. 3.

FIG. 5 illustrates a flow chart for a method for distribution of prescribed medicinal plants (MP) in a Voluntary Consignment Program (VCP).

FIG. 6 is a schematic diagram that illustrates the major components of a self contained medicinal plant grow environment system.

FIG. 7 is a side view of a self contained medicinal plant grow environment system as described in FIG. 6 and according to the present invention.

FIG. 8 is a top view of the self contained medicinal plant grow environment system shown in FIG. 7.

FIG. 9 is an end view of the self contained medicinal plant grow environment system shown in FIG. 7.

FIG. 10 is a flow chart of a mode of operation for using a self-contained medicinal plant grow environment system shown in FIG. 8 through FIG. 10.

### DETAILED DESCRIPTION OF THE INVENTION

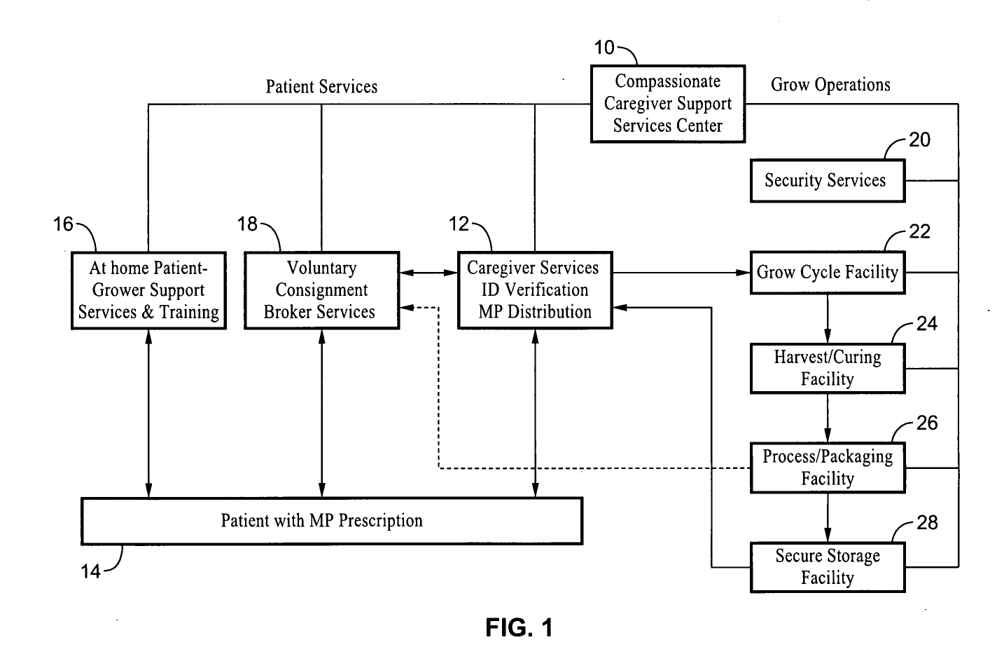

Referring more specifically to the drawings, for illustrative purposes the present invention is embodied in the apparatus generally shown in FIG. 1 through FIG. 10. It will be appreciated that the apparatus may vary as to configuration and as to details of the parts, and that the method may vary as to the specific steps and sequence, without departing from the basic concepts as disclosed herein.

California citizens have passed Proposition 215, the Compassionate Use Act of 1996 which is now Section 11362.5 of the California Health and Safety Code. Other legislative measures, such as California Senate Bill-SB 420, are pending and address procurement, possession and use of medicinal plants (MP), such as marijuana, for patients with a valid prescription from a physician. The subject matter of Section 11362.5 and SB 420 form a reference framework for the invention and are incorporated herein in their entirety.

A comprehensive medicinal plant (MP) Implementation Plan is understood to consist of the following essential elements: a Patient Qualification and Identification Plan, a Production Plan, a Distribution Plan and a Fee Collection Plan local and/or state government can use to collect fees and/or taxes as appropriate. The legislature has already defined the starting point by describing in SB 420 how an MP patient can avoid prosecution by presenting a valid physicians prescription to law enforcement. Optionally, arrest can be avoided through participation in a Voluntary I.D. Card Program. In addition the pending legislation has called for the assessment of certain local fees that may be considered a starting point for the development of a Fee Collection Plan.

The Legislature has not clearly defined a comprehensive Production Plan or a comprehensive Distribution Plan. These critical plan aspects have yet to be resolved, and as such represent undefined provisions of SB 420. The Compassionate Caregiver Support Services Center, described below, represents a comprehensive organizational template that allows an MP patient to satisfy the defined and undefined provisions of SB 420. One purpose of the Caregiver Support Services Center as described here is to assure the “fair and orderly implementation of the act” as well as to provide “guidelines to ensure the security and nondiversion of MP grown for medical use by patients,” just as the legislature has intended.

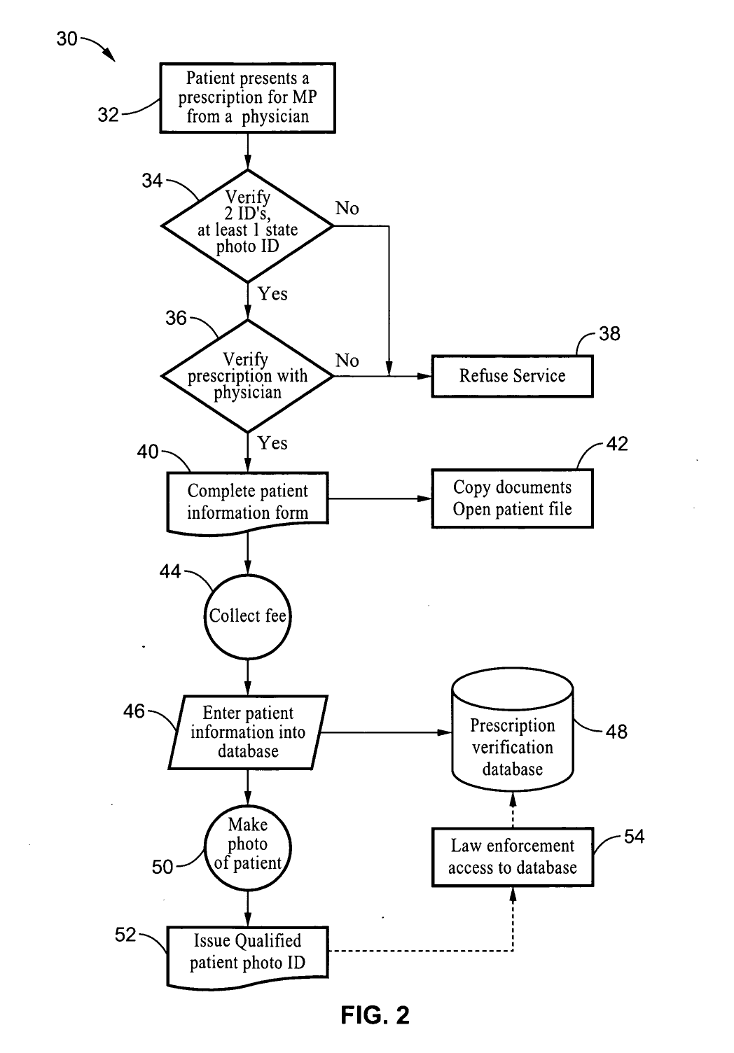

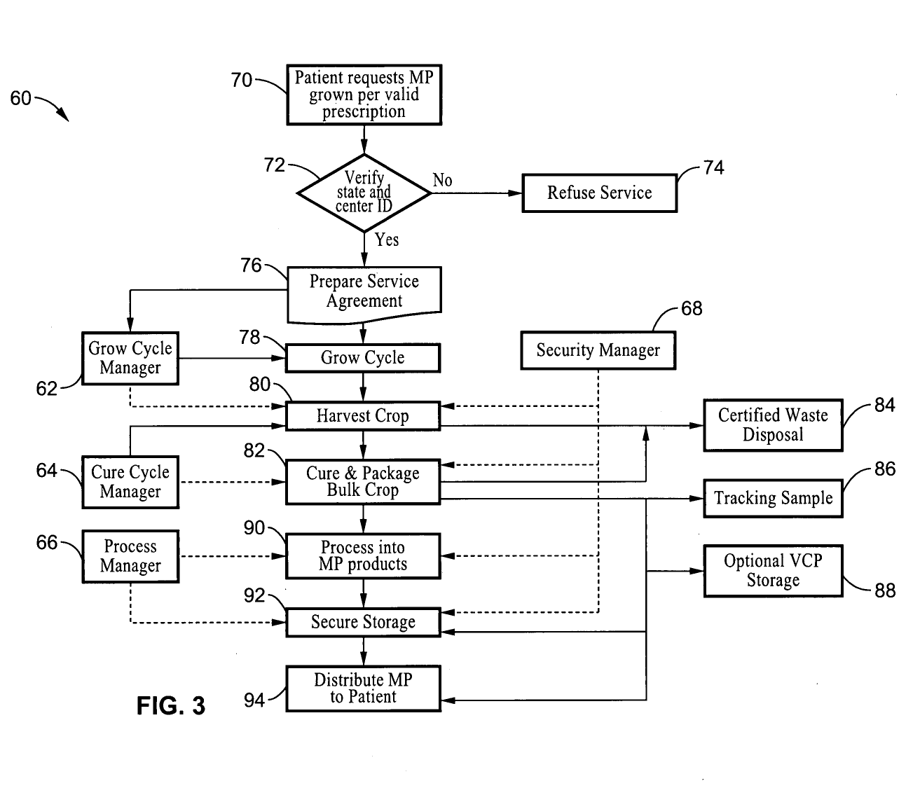

FIG. 1 illustrates an organizational chart of a Compassionate Caregiver Support Services Center (CCSSC) designated as 10. The CCSSC 10 is typically supported in a facility or group of facilities that provide services for patients with a valid prescription for MP. Patient services functions are positioned on the left of the chart and grow operation functions are positioned on the right of the chart. Caregiver services 12 is the primary interface for patients with a MP prescription 14. A patient with a valid medicinal plant (MP) prescription 14 would initially contact caregiver services 12 to verify ID, validate the prescription and, in one embodiment, be issued an ID card as will be further described in FIG. 2. The patient 14 can contract for Medicinal plants to be grown through grow operations as will be further explained in FIG. 3.

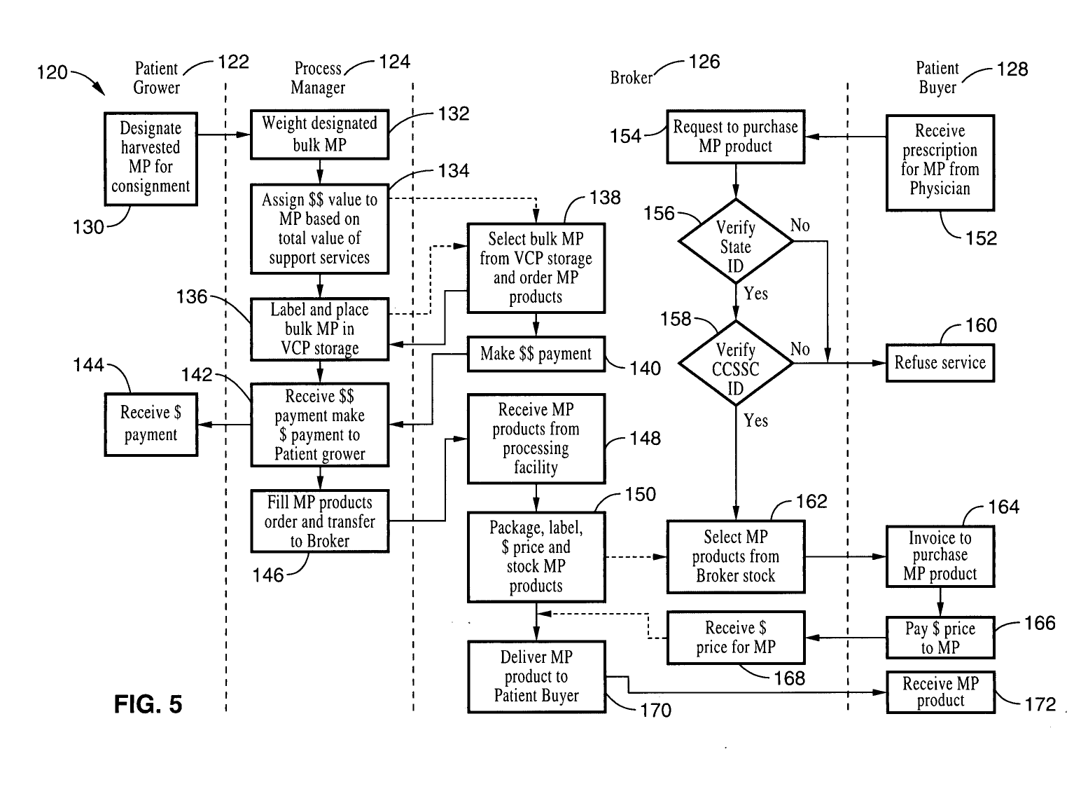

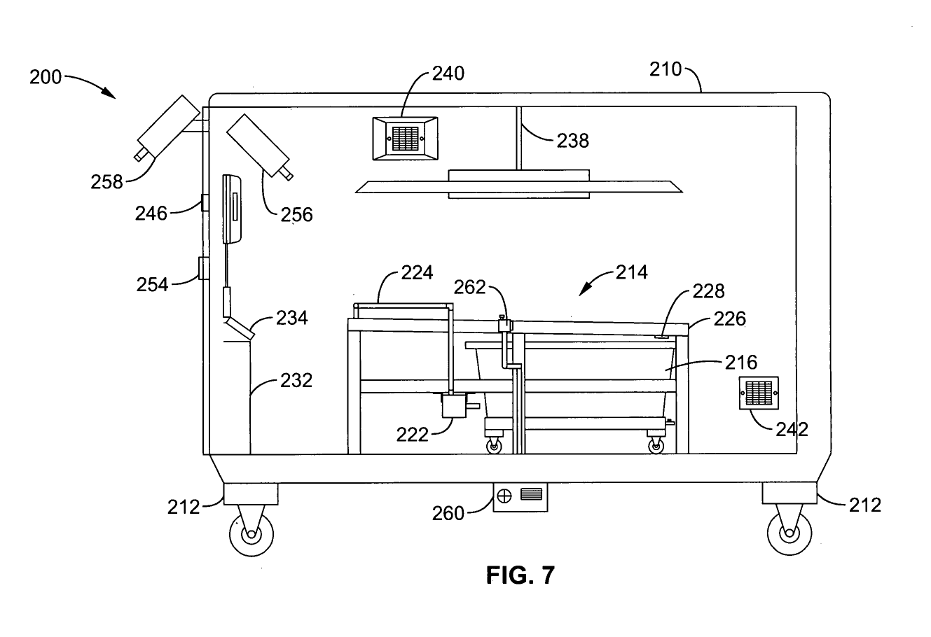

Patients 14 that prefer to grow their own MP can receive technical assistance and equipment rental through At Home Patient-Grower Support Services 16. At-home patient growers can also contract for one or more services provided under Grow Operations including use of a self-contained grow environment as described in FIG. 7 through FIG. 9. Patients 14 that just received a prescription and have not completed a grow cycle, or cannot grow their own MP, can procure MP through the Voluntary Consignment Broker Services 18 which will be further explained in FIG. 5.

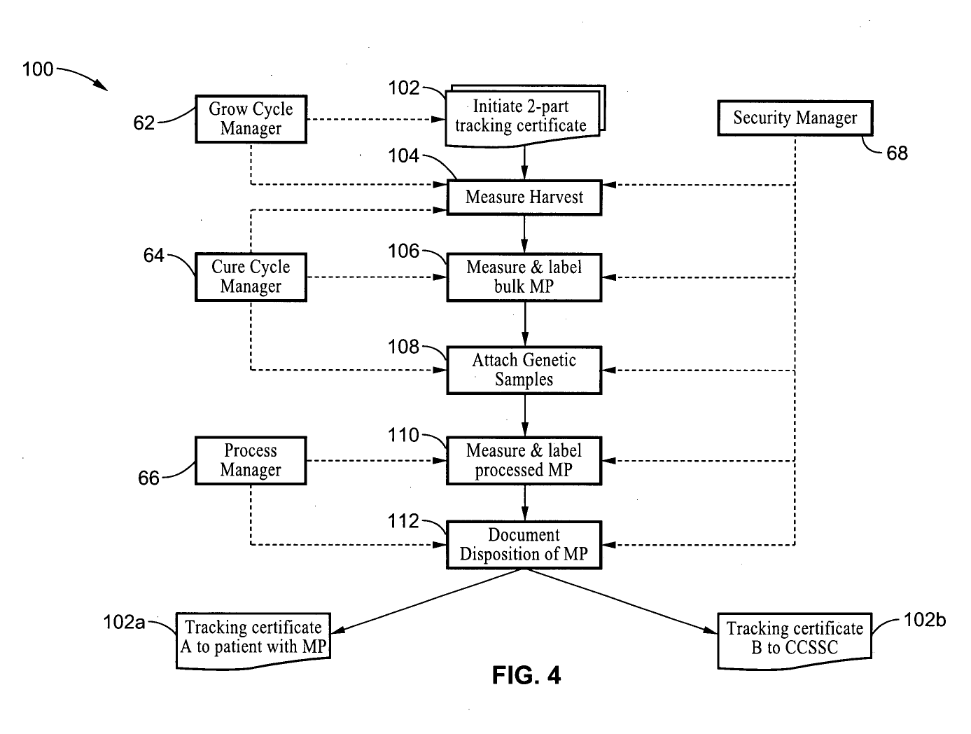

Referring to FIG. 1, the Compassionate Caregiver Support Services Center (CCSSC) 10 has several functions under grow operations to produce and distribute MP and MP products for patient clients. Security services 20 provides an important oversight and accountability function as will be further described in FIG. 3 and FIG. 4. The Grow Cycle Facility 22 is a location or facility where medicinal plants are grown under secure, monitored and controlled conditions. In one embodiment, medicinal plants are grown in small plots or partitions that correspond to possession limits prescribed by law. The Harvest/Curing facility 24 is a location or facility used to measure the grown MP, prepare the MP for use and separate usable MP from waste material. The Process/Packaging facility 26 is a location facility used to convert bulk MP into consumable products based on the patients medical needs and desires. A Secure Storage facility 28 is provided to ensure control and accountability of processed MP. Security Services 20 oversees the measurement and transfer of MP as it moves through grow operation functions and facilities and oversees transfers of MP in and out of Secure Storage 28.

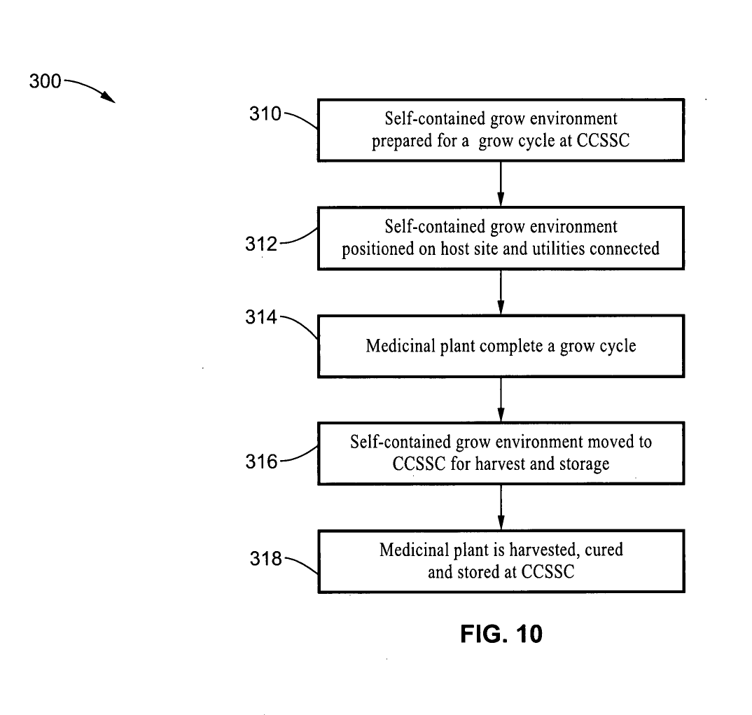

The CCSSC 10 provides support services for those desiring to grow for themselves at home. At Home Patient-Grower Support Services 16 offers a comprehensive Patient-Grower How-To course to include: review of applicable local, state and federal MP policy, constructing your indoor and outdoor grow spaces consistent with local building codes and ordinances, how to use the MP Chain of Custody Tracking Certificate to establish an effective legal defense, all aspects of scientifically managing the grow cycle, curing and processing techniques, packaging and storage, and safety and security issues. A method for using at home patient grower support services 16 is described in FIG. 10.

In the organization described above, the community relation's objective of a CCSSC is to set a good civics example by promoting the exercise of personal responsibility, demonstrating to patient's that their interests are best served by working within the system rather than from the outside, never condoning or encouraging MP use for other than medicinal purposes, and offering Center training and meeting facilities to community groups such as M, NA, etc.

Inputs are preferably received from various government agencies in order for the CCSSC business organization to be effectively implemented. As such a synergy of effort between the following agencies is preferred: District Attorney's Office and/or States Attorney General's Office, County Board of Supervisors (or equivalent), Building Code Enforcement and the Health Department.

For example, the State Attorney General may review the business plan and procedures to ensure it provided the security and nondiversion of MP grown for medical use, as specified. Also that patients maintain a valid MP prescription, participate in a voluntary (or required) I.D. Card program, demonstrate MP Point of Origin, demonstrate that MP production is within established grow limits, demonstrate that stored MP is secure, and demonstrate tracking procedures and disposition of each MP crop.

The District Attorney may want assurance that problems and uncertainties in the MP laws that have impeded the ability of law enforcement officers to enforce its provisions as the voters (legislators) intended are addressed. Specifically, assurance that the business model provides the prompt identification of qualified patients and their designated primary caregivers in order to avoid unnecessary arrest and prosecution of these individuals may be required. Promotion of uniform and consistent application of MP laws among the counties within the state is an important factor Also, is the access of patients and caregivers to MP enhanced through collective, cooperative cultivation projects.

Indoor grow spaces require a water supply, electrical supply, and HVAC capability. Building Standards must be applied in order to avert the types of hazards associated with make-shift indoor grow spaces. In order to assure such standards are maintained, periodic inspections are recommended. Therefore applicable standards are preferably identified and applied, and an inspection protocol developed for local jurisdictions.

Local counties and cities typically evaluate and approve/disapprove of business plans such as the proposed Compassionate Caregiver Support Service Center business method based on its conformity to law and local community standards. Further, local leaders may establish grow limits sufficient to permit the grower-patient to grow in excess of his near term needs so that a consistently reliable supply to Broker Services can be maintained for those patients that are disabled, unable, exposed to financial hardship, incarcerated or otherwise elect not to grow for themselves, and those patients waiting for their Service Agreement to be satisfied. They may also establish a building code enforcement inspection plan and associated fee structure, and consider the need for an annual use permit fee or occupation tax that can be levied against each producing individual grow space unit.

The local or county Health Department would preferably establish liaison point of contact person, to facilitate communication with and between the relevant government agencies, and develop oversight systems and methods as directed by the county board of supervisors.

FIG. 2 illustrates a method for issuing a qualified patient ID card designated as 30. In one embodiment, the ID is issued from the Compassionate Caregiver Support Services Center. In an alternative embodiment, patient ID cards are issued from a state or local health agency. A first step 32 is a patient with a valid prescription for MP presents the prescription at caregiver services 12 (as shown in FIG. 1) or a health care agency. Two forms of identification (ID), including at least one state identification with a photo are preferably presented and verified by staff at step 34. If the ID's are valid, staff will contact and verify the prescription with the issuing physician at step. If step 34 or step 36 are not valid, then service is refused at block 38. The patient will complete a patient information form with personal and/or credit information at step 40. Staff will preferably make a file copy of the ID's, the prescription and the patient information form at step 42. After collecting a fee at step 44, patient information is entered at step 46 into a prescription verification database 48. A photo of the patient is made at step 50 and a photo ID for access to services at the CCSSC is prepared and issued to the patient at step 52.

The prescription verification database 48 is preferably accessible to law enforcement 54 at all times to verify the status of a qualified patient who presents a qualified patient ID 52.

A similar process (not shown) can be used to issue a caregiver ID card to a person who is legally entitled to make medical decisions for the qualified patient.

FIG. 3 illustrates a flow chart for a method for procuring prescribed medicinal plants (MP) designated as 60. The dotted lines on the chart designate lines of responsibility or oversight for a grow cycle manager 62, a cure cycle manager 64, a process manager 66 and a security manager 68.

A patient with a valid prescription for MP makes a request 70 to have MP grown to fill the prescription. A valid photo ID as a qualified patient and a state ID is verified at step 72, preferably by staff in Caregiver Services 12 of the CCSSC as shown in FIG. 1. Service is refused at step 74 if ID verification cannot be accomplished. A service agreement is prepared at 76 that specifies the grow services that will be provided by the CCSSC. Service agreement specifications preferably include selection of MP crop (variety, clone or seed), quantity, and any MP products to be processed or produced from the harvested and cured crop. The service agreement can be for one grow cycle crop or for continual grow services for the term of the prescription. A copy of the signed service agreement is given to the grow cycle manager 62. The grow cycle manager initiates and manages the grow cycle 78 to yield a crop to meet the specifications of the service agreement. The grow cycle manager 62 may also initiates a MP chain of custody tracking certificate that will document the origin and handling of the MP crop. A method of preparing a tracking certificate is described in FIG. 4.

At the end of the grow cycle, the mature MP crop is harvested at step 80. The harvesting and weighing of the crop is performed by the grow manager 62 and witnessed by the cure cycle manager 64 and the security manager 68 who all annotate the tracking certificate. Waste MP crop parts, such as stalks and stems that cannot be used, are measured and packaged for disposal.

The harvested crop is transferred to the custody of the cure cycle manager 64 for drying/curing at step 82. Once the MP crop has cured, it is separated into bulk components, such as flowers and leaves, measured, packaged and labeled by the cure cycle manager 64. Both the cure cycle manager 64 and security manager 68 annotate a tracking certificate for the cured MP measurements and packages. Waste material from the cured crop is measured and packaged for disposal.

Unusable waste MP, such as stems, is preferably transferred to an independent service provider at 84 who will measure the waste and certify the disposal of the unusable MP. Documentation of disposal provides an assurance that MP has not been diverted. Unusable MP can be disposed of by incineration, shredding combined with soil burial, or other means accepted by state or local jurisdictions.

Small portions of the cured crop may be preserved as genetic tracking samples at 86. In one embodiment, genetic samples are placed in a plant anatomy sample holder attached to a tracking certificate. A portion of the bulk MP may also be transferred to a voluntary consignment program (VCP) storage area 88 at the patient's request. The VCP process is described in FIG. 5.

Still referring to FIG. 3, bulk MP to be processed is transferred from the cure cycle manager 64 to the custody of the process manager 66 at step 90 with oversight from the security manager 68. Bulk MP is processed into MP products at step 90 such as smaller MP doses, oils, butter or flour or the MP is combined with edible ingredients. MP products are packaged and measured by the process manager 66 under the oversight of the security manager 68. MP products are then placed in secure storage 92 or distributed to the patient at step 94.

A secure storage area 92 is provided where bulk MP and MP products can preferably be retrieved by the patient or by CCSSC staff on behalf of the patient. In one embodiment, access to the secure storage area 92 is controlled by the process manager 66 and the security manager 68 and all withdrawals and transfers are preferably annotated on a tracking certificate. In another embodiment, the patient inventories the MP products in the secure storage area 92 and annotates the service agreement and tracking certificate.

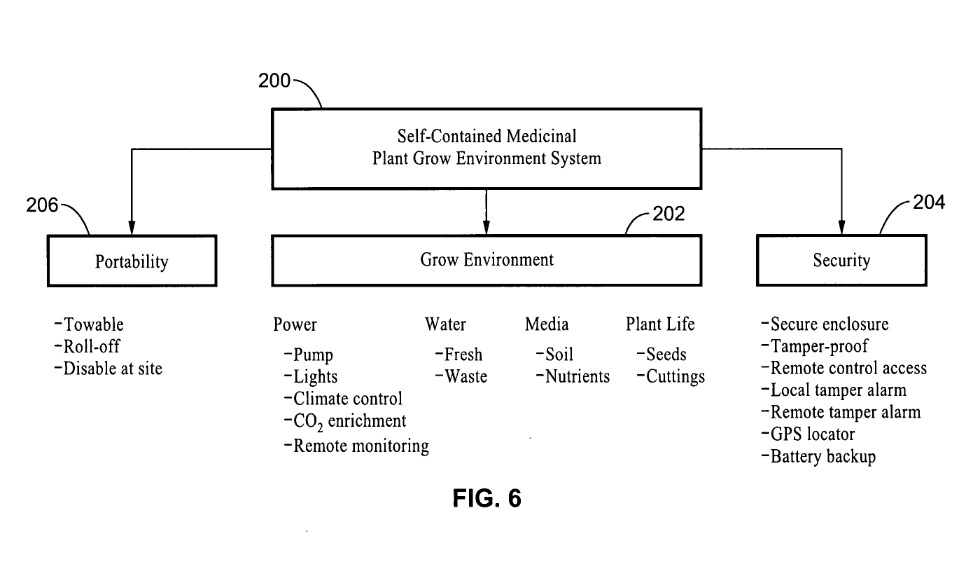

In an exemplary embodiment, the grow cycle step 78 may occur on the premises of the patient in their own grow environment or in a portable grow environment leased from the CCSSC as will be further described in FIG. 6 through FIG. 10.

FIG. 4 illustrates a flowchart for a method of preparing a chain of custody tracking certificate for MP designated as 100. In some jurisdictions, a patient with a prescription for MP is responsible for their own legal defense for possessing prescribed MP. A chain of custody tracking certificate may provide an auditable ledger of growing, curing and processing activities and could be used by a qualified MP patient to demonstrate the origin of MP in their possession. Additionally, a tracking certificate can display a tax stamp or seal to demonstrate that government levied fees have been collected.

The grow cycle manager 62 initiates a tracking certificate 102 preferably with at least two parts. When a MP crop is harvested, the measurement of the harvest 104 is documented on the tracking certificate 102 by the grow cycle manager 62, the cure cycle manager 64 and the security manager 68. The harvested MP is transferred to the custody of the cure manager 64. After curing, the MP is measured, packaged in bulk components and labeled at step 106. This process is documented on the tracking certificate 102 by the cure manager 64 and witnessed by the security manager 68. The cure manager 64 takes genetic samples of the MP and affixes them to the tracking certificate at step 108, preferably in a tamper evident enclosure.

The packaged, bulk MP is transferred to the custody of the process manager 66. The bulk MP is either processed into MP products at 110 or placed in secure storage as shown previously in FIG. 3. The disposition of the bulk MP and MP products is documented at 112 by the process manager 66 and witnessed by the security manager 68 on the tracking certificate 102.

The tracking certificate 102 is preferably separated into at least an A part, designated 102a and a B part, designated 102b. The A part 102a is issued to the patient when the prescribed MP is distributed. The B part 102b is preferably retained by the CCSSC. In further embodiments (not shown), additional copies may be accessed or retained by local government agencies or law enforcement. In a further embodiment (not shown), genetic samples are made available to law enforcement agencies as a means to deter or detect MP diversion and theft.

FIG. 5 illustrates a flow chart for a method for distribution of prescribed medicinal plants (MP) in a Voluntary Consignment Program (VCP) designated as 120. In some cases, there are patients with a valid MP prescription that cannot grow MP to meet their medical needs. Examples are individuals that are indigent or incarcerated. In other cases, a patient does not want to or cannot wait 90 to 120 days to complete a grow and cure cycle before filling a prescription for MP. In some jurisdictions, it may be illegal for an individual, organization or group to cultivate or distribute MP for profit. Further, in some jurisdictions, it may be illegal to sell, transfer or divert MP procured by one patient directly to another patient. In these jurisdictions, a process that uses an intermediary or broker to complete the transaction is preferably used.

In FIG. 5, four parties are represented in vertical columns from left to right: a patient grower 122, a process manager 124, a broker 126 and a patient buyer 128. In this example, both patient grower 122 and patient buyer 128 have valid prescriptions for MP. The patient grower 122 has completed a grow cycle and designates a quantity of bulk MP for consigned to the Voluntary Consignment Program (VCP) at 130. The consigned MP is measured, labeled with a coded tracking number at 132 and assigned a consignment value based on the total value of support services used to grow, harvest and package the bulk MP at 134. This consignment value represents reimbursement for the labor, materials and overhead expended by both the patient grower 122, the CCSSC (represented by process manager 124) and any applicable government taxes or fees. The consignment MP with its assigned consignment value and coded label is placed in a VCP storage location at step 134 and preferably under the control of the process manager 124.

A VCP broker 126 is preferably trained and licensed to manage MP transfers from a patient-grower 122 to a non-growing patient buyer 128. Broker 126 operates in a location separate from the process facility and VCP storage location and maintains an inventory of bulk MP and MP products that is available for sale to a qualified patient buyer 128 with a valid MP prescription. The broker 126 initially selects consigned bulk MP from the VCP storage at 138. The broker 126 may also request MP products to be manufactured from the selected MP at this step. The broker 126 pays the process manager the consignment value established at step 134 plus any costs to process MP into MP products at 140. A portion of the payment 142 received by the process manager 124 is used to reimburse at 144 for labor, materials and services expended by the patient grower 120 for growing the consigned MP. Bulk MP and/or MP products are transferred at 146 to the custody of the broker 126 by the process manager 124, preferably under the oversight of a security manager as previously described in FIG. 3. The broker 126 receives custody of the MP and MP products from the process manager 124 at 148 and packages, labels and prices the MP products and places them in the broker MP inventory at 150.

A patient buyer 128, represented on the chart in the far right column, has a valid prescription for MP at 152 and requests MP or MP products from the broker 126 at 154. The broker 126 preferably verifies the identity of the patient buyer with a state issued ID at 156 and a qualified patient photo ID at 158 as described previously in FIG. 2. If the patient buyer 128 cannot be properly verified, service is refused at 160.

The broker 126 fills the patient buyer 128 request by selecting bulk MP or MP products from the broker inventory at 162 and invoices the patient buyer for the purchase at 164. The patient buyer 128 pays the broker at 166 and, when payment is received and preferably verified at 168, the selected MP or MP products are delivered at 170 to the patient buyer 128 who receives the MP product at step 172 and the transaction is complete.

The use of a broker 126 and process manager 124 between a patient grower 122 and a patient buyer 128 is configured to assure patient confidentiality. The MP product can be traced from the patient buyer 128 back to its point of origin through the codes on the labels and transaction records of the MP, but the patient buyer 128 cannot be identified from the position of patient grower 122. This method assures patient confidentiality without sacrificing the patient buyer's ability to demonstrate point of origin. The patient grower 122 cannot determine the identity of the patient buyer 128 or offer to sell or transfer a particular consigned crop to a particular patient buyer 128. Further, the patient grower 122 cannot set the price for consigned MP. The patient buyer 128 cannot specify or identify MP or MP product consigned from a particular patient grower 122 or negotiate with a patient grower 122 for the price of MP. Using a reimbursement valuation system removes profit motive for a patient grower 122 to produce MP in excess of their medicinal needs.

In a further embodiment (not shown), a tracking certificate as described in FIG. 4 is provided to the patient buyer 128 with the MP or MP products sold by the broker 126.

FIG. 6 is a schematic diagram that illustrates the major components of an embodiment of a self contained medicinal plant grow environment system designated as 200. It is to be understood that the fabrication and assembly of specific components can be accomplished by various means known in the art. Further some components may be commercially available and provided as complete assemblies or systems.

In a preferred embodiment, there are three major sub-systems to the self contained medicinal plant grow environment system 200; a grow environment 202, a security system 204, and portability of the grow environment 206.

The grow environment 202 is a self contained enclosure with all the equipment and components necessary to grow a medicinal plant through a grow cycle to maturity. The grow environment is typically positioned for use where external power, water and water disposal is available. External power is used primarily for irrigation pumps, grow lights and, climate control. Climate control includes temperature, humidity and air flow and typically uses fans and heaters. In a preferred embodiment, a CO₂ enrichment system is used in the grow environment to promote rapid growth. An external water supply from municipal water or nearby water storage is connected to the grow environment. Water is used primarily for irrigation and delivery of nutrients. Waste water disposal can be municipal sewer, tile field, temporary storage or other suitable agricultural water disposal method.

The grow environment 202 is equipped with sufficient media, such as soil, to support medicinal plant growth for at least one grow cycle. Similarly, sufficient nutrients, such as fertilizer, are provided to support at least one grow cycle. The grow environment 202 is configured to accommodate seeds or cuttings of medicinal plants for at least one grow cycle and, in a preferred embodiment, the seeds or cuttings are planted in the media for the start of each grow cycle.

It is commonly understood that the outcome of each grow cycle is dependent on the environmental conditions under which the grow cycle has been conducted. The species-specific indigenous environmental conditions represents nature's baseline. Replication and management of baseline environmental conditions in foreign growing venues are required to assure a desirable grow cycle result.

The Self-Contained Medicinal Plant Grow Environment System 200 substantially replicates species-specific indigenous growing environments. Foreign out-door grow environments can not fully replicate the indigenous conditions, however, a partial replication of the indigenous grow conditions is possible. The extent to which indigenous environmental conditions are replicated (either in-door or out-door) determines the outcome of the grow cycle.

In short, the present invention seeks to replicate the indigenous grow environment either partially or fully, within a fully self-contained environmental grow enclosure or exposed to the local out-door environment.

Initially, environmental and replication control starts with monitoring of the species specific indigenous grow conditions around the world. This information provides a basis for Environmental Control Unit (ECU) software.

Further, monitoring and comparing of the replicated indigenous grow conditions within the grow environment 202 or foreign out-door plots (example: outdoor plot in California) is controllable through the ECU.

The grow environment 202 represents the hardware aspect of the grow cycle. Dedicated indigenous climate monitoring is also present. The software aspect is represented in the programming functions that allow the hardware to duplicate the indigenous climate and nutritional conditions. Such data is contemplated to be collected through monitoring. Such monitoring may be linked directly to the self-contained grow enclosure via data-link for real time duplication of indigenous conditions in the self-contained grow environment, or the data may be transmitted to a central facility, archived, then reproduced in CD format for use in the controlling PC platform. Monitoring is contemplated to utilize video and/or telemetry feed data.

The data parameters monitored may include but is not limited to: Temperature, Humidity, Rainfall, Dew accumulation, Soil nutritional composition, Light (intensity, duration, and spectrum composition), Wind, and Dew point.

Another element is a water and nutritional delivery system applicable to in-door and out-door growing venues. In addition, applicability is meant to include delivery systems that are either fixed or portable, (note: fixed may be either within the confines of a Center or adapted to a private in-home facility) Controllable through the ECU.

A further element is a light exposure control means. All grow venues may exclusively utilize artificial light source(s), natural light source(s), or a combination of natural and artificial light sources. Translucent screens, opaque screens, louvers and other light modulating techniques are applicable and Controllable through the ECU.

Air quality parameters such as Temperature, humidity, air-flow, and CO₂ parameters are controllable through the ECU.

The Environmental Control Unit (ECU) with programmable software will allow the indigenous environmental conditions to be replicated. Programming variables are derived from indigenous monitoring or from artificial sources.

Means of physical security such as secure entry door interlock systems where entry may be controlled on site or from a remote access control site are included as security 204. Video surveillance is provided for the interior and exterior. Surveillance will preferably be of the entry door (interior and exterior). Surveillance will also apply to the grow space proper (indoor grow table or out-door grow plot). External area surveillance of avenues of approach to either in-door or out-door grow venues can be controllable through the ECU.

For portable grow venues, a motion sensor, alarm system and/or GPS tracking system will alert the controlling authority of potential theft or tampering.

In another embodiment of a self-contained enclosure configured to replicate the indigenous climate and nutritional grow conditions of a plurality of medicinal plants, two configurations are contemplated. First, a modularly constructed enclosure to be permanently installed in one fixed location (for example installed in dedicated arrayed spaces similar to those found in a mini storage facility). Second is a fully assembled portable enclosure. Such units may use trailer or roll-off technology similar to that used in commercial waste removal dumpster/roll off bins.

Components common to both modularly constructed and portable configured embodiments are described below and include (but are not limited to) a water reservoir, a reservoir tank (serves to mix and store the fertilizer/water emulsion), an air pump (fish tank aerator), a circulation pump (to maintain consistency of water/fertilizer emulsion), a transfer pump (transfers water/fertilizer emulsion to plants via PVC piping and an array of appropriately placed drip lines), a cold water supply (float valve and water source combine to maintain the water level in the reservoir), and a Fertilizer dispensing means (a fertilizer dispensing unit is attached to the reservoir). Fertilizer concentration is a function of water volume and fertilizer is added to the emulsion in real time as water is added.

Another common element is a means of control (the system will be controlled through programmable timer technology. Semi and fully automatic modes are contemplated with fully automatic preferred. The system will be able to be controlled through either on-site or remote means.

Further components common to both modularly constructed and portable configured embodiments include: a grow table appropriately sized (fixed or adjustable in slope with at a minimum 1 degree fixed down-slope minimum), Rock wool or other appropriate grow medium (rests on the table), emulsion containment means (to keep the emulsion channeled through the grow medium so it does not run off the sides of the table), emulsion supply/return lines (attached to the up-slope end of the grow table with a drain and return line that transfers the excess emulsion back to the reservoir) where the supply line attaches to an array of appropriately positioned drip lines.

Still further common elements include lighting, typically Metal Halide or High Pressure Sodium as required, an oscillating light track system or stationary array of lights, a timer controller (on-site or remote control capability), an air handling system, on-site or remotely controlled and/or monitored (by computer), fresh air intake (from outside ambient air. Air may optionally be routed through an A/C-heating unit to modulate temperature through thermostat control), one or more exhaust fans (to vent heat build-up from lighting hoods and the open space proper), a CO₂ dispenser, and internal climate monitoring (used to record the specific conditions under which the crop was grown).

Climate control is required where preferably all time sensitive mechanical and communications functions of the enclosure will be controlled by a PC platform. The controlling software will be derived though the monitoring the indigenous climate of each plant species. The data collections parameters of a dedicated climate monitoring device include: external utility hook-ups such as Electrical, Water, Data and Security Systems.

An optional plant trellis may be used to secure plants in a grow enclosure.

For portable configurations of a grow enclosure, a floor leveling means (needed to assure appropriate grow table slope and as a security device intended to make the enclosure more difficult to move), GPS, vibration, and/or tilt based motion sensing (will activate an alarm system if movement of the unit is attempted), and detachable (quick disconnect) utility hook-ups may be included.

Portability features 206 are integrated into the system 200. In one embodiment, the grow environment 202 is integrated into a towable trailer. This allows convenient placement on an selected site during the grow cycle and convenient repositioning for harvest or replenishment. In a preferred embodiment, towability is disabled during a grow cycle. In another embodiment, the grow environment 202 is configured as a roll-off container for transport and placement, in a manner similar to a commercial shipping container or a commercial waste container.

Security 204 is a major sub-system of the self contained grow environment system 200. Because of desirability, some medicinal plants are targeted for theft or diversion. The grow environment 202 is secured in a tamper-proof enclosure, typically of a strong material such as metal. In one embodiment, a secure access door with one or more locking systems is provided in the enclosure. In a further embodiment, a remote signal, such as a radio signal, is required to unlock the access door. In another embodiment, two persons, such as a host and an entity representative, both have separate keys or codes and both must be present to open the access door to the grow environment. In a further embodiment, the grow environment 202 is equipped with a local and/or remote alarm system that activates when attempted tampering is detected. In a still further embodiment, a Global Positioning System (GPS) with a transmitter is integrated into the grow environment to verify the current location and signal any unauthorized or attempted movement of the grow environment.

A battery back up system is provided in an exemplary embodiment to ensure the security features continue to operate if external power is disconnected. Security may include a secure entry door (tamper evident log-in, log-out coded entry means) where entry may be optionally controlled by remote (with or without a manual override), and Video surveillance (optional 24/7 interior and exterior monitoring).

Additional systems that monitor controls or plant growth, and display locally or transmit remotely the status of controls or plant growth, are used in an exemplary embodiment of the grow environment 202.

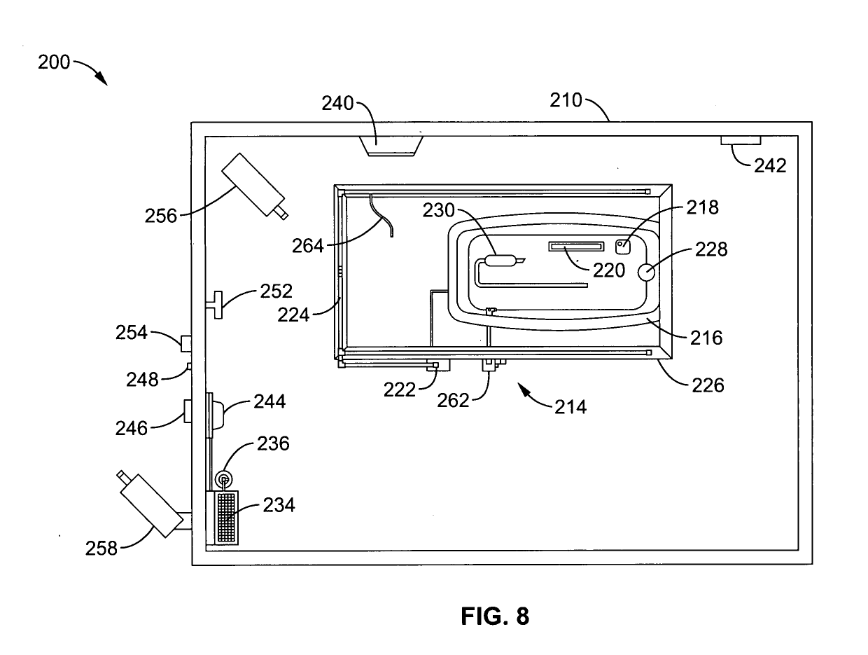

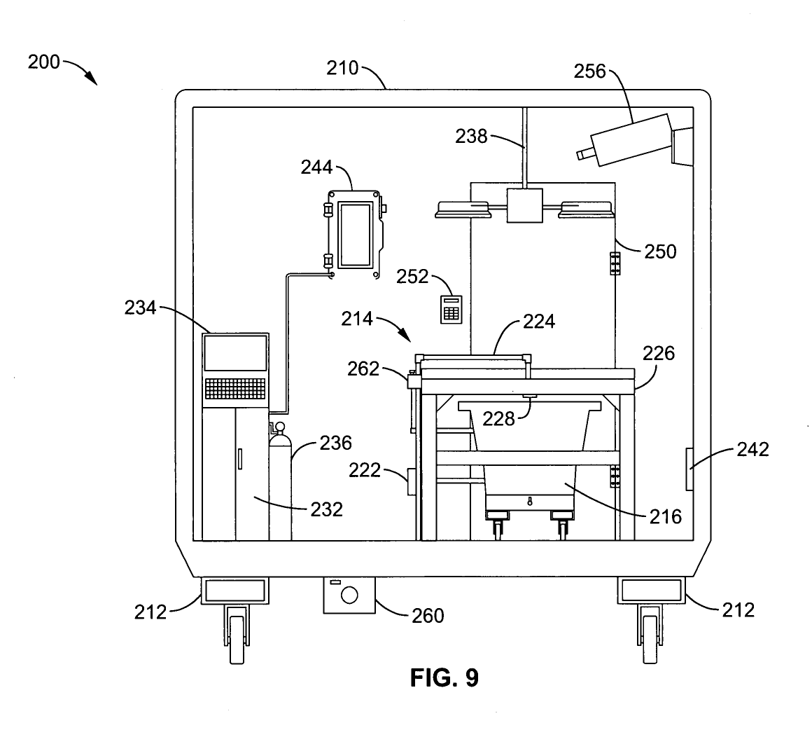

FIG. 7 is a side view, FIG. 8 is a top view and FIG. 9 is an end view that illustrates one embodiment of a self contained medicinal plant grow environment system 200 as described in FIG. 6 and according to the present invention.

Self contained medicinal plant grow environment system 200 has secure enclosure 210 that houses or supports the subsystems. Wheels 212 are shown mounted to the bottom of enclosure 210 to provide portability. Inside enclosure 210 is shown with a grow table assembly 214 including components commonly used in commercial grow environments. Grow table assembly 214 has a portable basin 216 for water storage and is equipped with an aerator 218 and a heater 220 shown in FIG. 8. A transfer pump 222 is connected to the basin and is configured to pump water from the basin 222 and through irrigation tubes 224 on the periphery of the table bed 226. A drain 228 in the table bed 226 returns unused irrigation water to the basin for recycle. The table bed 226 is adapted to support plant media and medicinal plants through a grow cycle. A circulation pump 230 is positioned in basin 222 and used to maintain a consistent water quality.

An environmental control unit 232 has a PC like interface 234 to program environmental control sequences in control unit 232. One control parameter is the release of CO₂ gas from tank 236. Other parameters include control of grow lights 238, exhaust fan 240, heater 220 and pumps 222 and 230. A fresh air intake 242 is shown that works in conjunction with exhaust fan 240. In enclosed environments, grow lights 238 are suspended above the table bed 226 to promote plant growth. The lighting system 238 can be fluorescent, high pressure sodium, metal halide or other light source as desired. The fresh air intake 242 may be heated, air conditioned, humidified or dehumidified as required.

A circuit breaker box 244 is shown on the interior wall of enclosure 210. Utilities such as electricity 246 and water 248 are shown connected to enclosure 210. Utilities that may be connected but are not shown include communications and drains.

Security systems include a security door 250 with interior door interlock panel 252 and exterior door interlock panel 254. In an exemplary embodiment, an end panel of secure enclosure 210 can be removed for access to the grow table assembly 214. An inside video camera 256 and an outside video camera 258 are positioned to observe and record adjacent activities. A motion detector 260 is shown mounted on the underside of secure enclosure 210 for additional security. In an exemplary embodiment, detector 260 is a GPS transponder.

In an exemplary embodiment, a fertilizer injection system 262 is integrated into the grow table assembly 214 and used to provide soluble fertilizer in the water circulating in portable basin 216. In FIG. 8 a drip line 264 is shown attached to irrigation tubes 224 to provide water and nutrients at a specific location as necessary.

FIG. 10 is a flow chart of a preferred mode of operation to use a self-contained medicinal plant grow environment system designated 300. In a preferred embodiment, the grow environment is housed in a secure enclosure.

Initially at 310, an entity licensed to grow, prepare, store and distribute medicinal plants, such as the CCSSC described in FIG. 1 through FIG. 6, prepares the grow environment for a grow cycle at their licensed and secure facility. Preparation might include but is not limited to preparing media for planting, adding nutrients, setting controls and planting cuttings or seeds.

Next at 312, the grow environment is transported and secured on a site owned or controlled by an individual or entity authorized to possess and/or use the medicinal plant. An example would be a patient with a valid prescription for MP. External power, water and water disposal are preferably connected to the grow environment, climate controls are adjusted and security systems are activated.

At step 314, the grow environment operates secure and inaccessible on the site during most or all of the grow cycle. Periodic visits by technical personnel of the CCSSC may be made to the grow environment to monitor or adjust plant growth and verify security. Law enforcement or government agency personnel may also visit and/or access the grow environment during this step.

In step 316, when the grow cycle is complete (typically after 90 to 120 days), the grow environment is securely transported to a licensed facility, such as the CCSSC. The MP is harvested, cured, and/or stored at step 318 for distribution to the patient grower.

In a preferred mode of operation, the patient grower hosting the grow environment during the grow cycle would retain an ownership interest in some or all of the medicinal plant harvested.

In a further mode of operation, a government controlled site is the host site to provide additional security and accountability. The government controlled site can be dedicated and configured for supporting grow environments or can be an existing site adapted for this use, such as the parking lot adjacent to a local police department or prison facility.

In some geographic locations, the quantity of medicinal plants in possession of an individual at any one time may be regulated. In an exemplary embodiment, the grow environment can be adapted to possession regulations by restricting available media area, metering power and water consumption, or with the use of government inspector tamper seals on the access door to the grow environment during the grow cycle. For example, one proposed regulation specifies 12 immature plants or 6 mature plants of MP for possession by a qualified patient.

There are a number of existing individual/entity and government/entity business models available to support the aforementioned modes of operation. An individual can lease the grow environment from the entity for a grow cycle. An individual can own a time share in a grow environment and pay a service fee to the entity for the operation of a grow cycle or sublease it to others. The government could operate the grow environment and collect royalties or fees for each grow cycle from the entity.

Table 1 illustrates a fee structure in table form that can be applied to the methods and procedures for procuring MP described in FIG. 2 through FIG. 5 and in FIG. 10. The discrete steps of the aforementioned methods and procedures provide a framework under which government taxes and fees can be assessed and collected to ensure that the cost of MP and MP products to a patient grower or patient buyer is at least equal to the prevailing market prices of MP.

Across the top of the table are the services provided, fees that can be charged at the CCSSC, government fees, sales tax and references to SB 420, a legislative bill in California that has specific provisions for medicinal plant possession, and procurement. The rows of the table refer to steps in the methods described in FIG. 2 through FIG. 5. and in FIG. 10.

This price and fee structure in Table 1 can be adjusted as necessary to remove any profit and diversion motive for a patient grower while allowing a for profit business to exist for some of the methods, steps and procedures described previously. In some jurisdictions, a non-diversionary intent must be demonstrated or incorporated into the methods and procedures for distributing MP.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

TABLE 1

| | | | | Profit Allowed |
|---|---|---|---|---|
| Service | Center Fee | Government Fee | Sales Tax | Under |
| Provided | Charged | Charged | Charged | SB420 |
| Center Membership, | Yes | Yes | Yes | Yes |
| Prescription | | | | |
| Verification & I.D. | | | | |
| Card | | | | |
| Individual Grow Space | Yes | Potential Use Permit | Yes | Yes |
| Rental & Maintenance | | or Occupation Tax | | |
| Service Agreement | | May Apply | | |
| Chain of Custody | Yes | Potential Law | Yes | Yes |
| Tracking System | | Enforcement | | |
| | | Surcharge May Apply | | |
| Processing and | Yes | Potential¹ | Yes | Yes |
| Packaging Services | | Administrative | | |
| | | Surcharge May Apply | | |
| Secure Bulk Storage & | Yes | No | Yes | Yes |
| Transportation | | | | |
| Voluntary | Yes | Potential² | Yes(Limited | Not |
| Consignment Program | | Transfer Fee or Tax | to Brokers | Addressed in |
| (Broker Fee) | | May Apply | Fee) | SB420 |
| Educational Services | Yes | No | Yes | Yes |

¹The county may elect to require each Processor to be licensed, in such instances an applicable Licensing Fee will apply.
²The county may elect to require each Broker to be licensed, in such instances an applicable Licensing Fee will apply.

1-26. (canceled)

27. A method for using a grow environment enclosure adapted for growing medicinal plants, comprising:
providing a portable grow environment enclosure having a medicinal plant support structure, an irrigation system, a light system and a security system;
preparing said medicinal plant support structure for a grow cycle of medicinal plants with media, nutrients and seeds or cuttings;
transporting the grow environment enclosure to a host site;
operating said irrigation system and said light system;
completing a grow cycle of the medicinal plants;
transporting the grow environment enclosure from said host site to a location adapted for harvesting medicinal plants; and
harvesting the medicinal plants at said location.

28. A method as recited in claim 27, further comprising providing a climate control system for said grow environment enclosure.

29. A method as recited in claim 27, further comprising providing a CO₂ enrichment system for said grow environment enclosure.

30. A method as recited in claim 27, further comprising providing a radio receiver adapted to receive an access code to permit access to said grow environment enclosure.

31. A method as recited in claim 27, further comprising connecting electricity to said grow environment enclosure.

32. A method as recited in claim 27, wherein said host site is controlled by a patient with a physician issued prescription for medicinal plants.

33. A method for procuring a medicinal plant for a patient having a physician issued prescription for medicinal plants, comprising:
providing a grow cycle facility, a harvest/cure facility and a process/package facility;
verifying the prescription with the issuing physician;
growing said medicinal plant in said grow cycle facility;
transferring said medicinal plant said harvest/cure facility;
harvesting and curing said medicinal plant in said harvest/cure facility;
transferring said medicinal plant to said process/package facility;
packaging said medicinal plant in said process/package facility; and
delivering said packaged medicinal plant to said patient.

34. A method as recited in claim 33, further comprising:
providing a security manager;
witnessing the transfer of said medicinal plant from said grow cycle facility to said harvest/cure facility by said security manager; and
witnessing the transfer of said medicinal plant from said harvest/cure facility to said process/package facility by said security manager.

35. A method as recited in claim 33, further comprising:
preparing a chain of custody tracking certificate witnessed and signed by said security manager; and
providing said chain of custody tracking certificate to said patient.

36. A method of procuring medicinal plants for a patient having a physician issued prescription for medicinal plant, comprising:
providing a grow facility and a curing facility;
verifying the identity of the patient by matching at least two identification cards with the patient;
verifying the medicinal plant prescription by contacting the issuing physician;
preparing a written agreement to grow medicinal plants;
growing medicinal plants in said grow facility;
curing said medicinal plants in said curing facility;
packaging said cured medicinal plants; and
distributing said packaged medicinal plants to said patient.

37. A method as recited in claim 36, further comprising:
providing a secure storage facility; and
storing said packaged medicinal plants in said secure storage facility.

38. A method as recited in claim 36, further comprising:
dividing said cured medicinal plants into usable and unusable medicinal plant material;
disposing of said unusable harvested medicinal plant material; and
packaging said usable harvested plant material.

39. A method as recited in claim 36, further comprising processing said cured medicinal plants into edible medicinal plant products.

40. A method of distributing medicinal plants from a first patient with a first prescription for medicinal plants and possessing a quantity of medicinal plants to a second patient having a second prescription for medicinal plants, comprising:
transferring a portion of the quantity of medicinal plants from the first patient to the custody of a broker;
verifying the identity and second prescription of the second patient; and
transferring said portion of the quantity of medicinal plants from custody of said broker to the second patient.

41. A method as recited in claim 40, further comprising:
transferring a first fee from said broker to said first patient; and
transferring a second fee from said second patient to said broker.

42. A method as recited in claim 40, further comprising:
placing said quantity of medicinal plants from said first patient in custody of a process manager; and
transferring a portion of the quantity of medicinal plants from said process manager to said broker.

43. A method of distributing medicinal plants from a first patient with a first prescription for medicinal plants and possessing a quantity of medicinal plants to a second patient having a second prescription for medicinal plants, comprising:
transferring a portion of the quantity of medicinal plants from said first patient to custody of a process manager;
packaging said portion of medicinal plants;
transferring said packaged portion of medicinal plants from said process manager to custody of said broker;
verifying the identity and second prescription of the second patient; and
transferring said packaged portion of medicinal plants from custody of said broker to the second patient.

44. A method as recited in claim 43, further comprising:
transferring a first fee from said broker to said process manager;
transferring a second fee from said process manager to the first patient; and
transferring a third fee from said second patient to said broker.

45. A method as recited in claim 43, further comprising:
calculating said first fee based on total reimbursement value of producing said portion of medicinal plants; and
calculating said second fee based on reimbursement value to said first patient of producing said portion of medicinal plants.

46. A method of providing a chain of custody tracking document for growing a medicinal plant for a patient having a physician issued prescription for a medicinal plant, comprising:
providing a growing manager, a curing manager a security manager and a tracking certificate;
growing a medicinal plant under control of said grow manager;
harvesting said medicinal plant by said grow manager;
documenting harvest and measurement of said medicinal plant by said grow manager, said curing manager and said security manager on said tracking certificate;
curing said harvested medicinal plant under control of said curing manager;
documenting measurement and packaging of said cured medicinal plant by said curing manager and said security manager on said tracking certificate; and
issuing said tracking certificate to said patient.

47. A method as recited in claim 46, further comprising:
preserving at least one sample of said medicinal plant for genetic evidence; and
attaching said sample to said tracking certificate.

48. A method as recited in claim 46, further comprising:
dividing said harvested medicinal plant into usable and unusable medicinal plant material;
measuring said usable harvested plant material;
measuring said unusable harvested plant material;
disposing of said unusable harvested medicinal plant material; and
providing a certificate of disposal with the measurement of said unusable medicinal plant material to said patient.

49. A method as recited in claim 46, further comprising:
providing a process manager;
processing said cured medicinal plants under control of said process manager; and
documenting measurement and packaging of said processed medicinal plant by said process manager and said security manager on said tracking certificate.

50. A method as recited in claim 49, further comprising:
storing said processed medicinal plants in a secure storage; and
documenting the quantity of said processed medicinal plants stored by said process manager and said security manager on said tracking certificate.
